(19) United States
(12) Patent Application Publication
(10) Pub. No.: US 2026/0046383 A1
(43) Pub. Date: Feb. 12, 2026

(54) STEREOSCOPIC DISPLAY SYSTEM AND STEREOSCOPIC DISPLAY METHOD

(71) Applicant: Acer Incorporated, New Taipei City (TW)

(72) Inventors: Sergio Cantero Clares, New Taipei City (TW); Shih-Hao Lin, New Taipei City (TW)

(73) Assignee: Acer Incorporated, New Taipei City (TW)

(21) Appl. No.: 18/798,757

(22) Filed: Aug. 8, 2024

(51) Int. Cl. H04N 13/117; H04N 13/122; H04N 13/156; H04N 13/305

(52) U.S. Cl. CPC H04N 13/117; H04N 13/122; H04N 13/156; H04N 13/305

(57) ABSTRACT

An exemplary embodiment of the invention provides an stereoscopic display method for a stereoscopic display system. The method includes: obtaining a display frame; cropping a 3D content image segment from the display frame, wherein the display frame comprises the 3D content image segment and a background content image segment; obtaining a left sub-image and a right sub-image based on the 3D content image segment; generating a left eye image and a right eye image according to the left sub-image, the right sub-image and the background content image segment of the display frame; and displaying a 3D composite frame in a stereoscopic displaying effect according to the left eye image and the right eye image by using a 3D display.

### BACKGROUND OF THE INVENTION

### Field of the Invention

The invention relates to an image processing technology and particularly relates to a stereoscopic display method and a stereoscopic display system.

### Description of Related Art

With the advancement of display technology, display apparatuses that support stereoscopic displaying technique have gradually become popular. The difference between stereoscopic display and two-dimensional (2D) display is that stereoscopic displaying technology allows a viewer to perceive a three-dimensional feel of the image, such as three-dimensional facial features of a character or a scene depth, while the traditional 2D images cannot present such an effect. The principle behind the stereoscopic displaying technology is to let a left eye of the viewer to watch a left-eye image and a right eye of the viewer to watch a right-eye image, so as to allow the viewer to perceive the three-dimensional (3D) visual effect. With the vigorous development of 3D stereoscopic display technology, it can provide people with a visually immersive experience. However, the availability of 3D content accessible to users is currently quite limited. Consequently, even when users possess a naked-eye stereoscopic display, they may still find themselves unable to fully and freely appreciate the immersive effects offered by such displays. Furthermore, naked-eye stereoscopic displays are typically constrained to displaying 3D content in full-screen, which restricts the range of applications for stereoscopic display functions.

### SUMMARY OF THE INVENTION

The invention provides a stereoscopic display system and stereoscopic display method, which can effectively resolve the above problems.

An exemplary embodiment of the invention provides a stereoscopic display method. The stereoscopic display method includes: obtaining a display frame; cropping a 3D content image segment from the display frame, wherein the display frame comprises the 3D content image segment and a background content image segment; obtaining a left sub-image and a right sub-image based on the 3D content image segment; generating a left eye image and a right eye image according to the left sub-image, the right sub-image and the background content image segment of the display frame; and displaying a 3D composite frame in a stereoscopic displaying effect according to the left eye image and the right eye image by using a 3D display.

Another exemplary embodiment of the invention provides a stereoscopic display system which includes a 3D display, a storage device, and at least one processor. The at least one processor is coupled to the storage device and the 3D display. The at least one processor is configured to: obtaining a display frame; cropping a 3D content image segment from the display frame, wherein the display frame comprises the 3D content image segment and a background content image segment; obtaining a left sub-image and a right sub-image based on the 3D content image segment; generating a left eye image and a right eye image according to the left sub-image, the right sub-image and the background content image segment of the display frame; and displaying a 3D composite frame in a stereoscopic displaying effect according to the left eye image and the right eye image by using a 3D display.

Based on the above, the 3D content image segment is cropped from the display frame, and the left sub-image for the left eye and the right sub-image for the right eye are respectively obtained based on the 3D content image segment. The left eye image is rendered to include the left sub-image and background content of the display frame. The right eye image is rendered to include the right sub-image and background content of the display frame. Therefore, when displaying the 3D composite frame in the stereoscopic displaying effect according to the left eye image and the right eye image, 2D content and 3D content may be simultaneously presented on the 3D display.

In order to make the aforementioned and other objectives and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a stereoscopic display system according to an embodiment of the invention.

FIG. 2 is a schematic diagram of a 3D display according to an embodiment of the invention.

FIG. 3A is a schematic diagram of displaying a frame without stereoscopic displaying effect by the 3D display according to an embodiment of the invention.

FIG. 3B is a schematic diagram of displaying a frame with stereoscopic displaying effect by the 3D display according to an embodiment of the invention.

FIG. 4 is a schematic diagram of a stereoscopic display method according to an embodiment of the invention.

FIG. 5 is a schematic diagram of generating a 3D composite frame based on an input frame according to an embodiment of the disclosure.

FIG. 6 is a flowchart of determining the ROI position for cropping the 3D content image segment according to an embodiment of the invention.

FIG. 7 is a flowchart of obtaining the left sub-image and the right sub-image according to an embodiment of the invention.

FIG. 8 is a schematic diagram of controlling perceived location of the background content image segment according to an embodiment of the disclosure.

FIG. 9 is a flowchart of a stereoscopic display method according to an embodiment of the invention.

### DESCRIPTION OF THE EMBODIMENTS

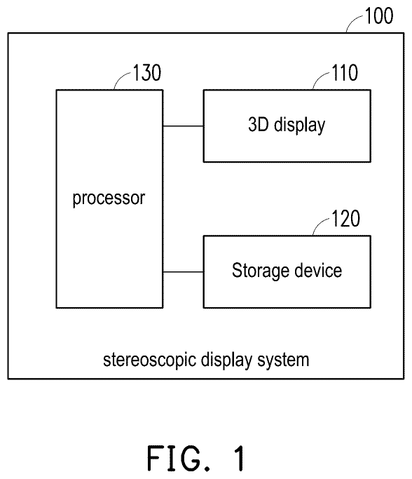

FIG. 1 is a schematic diagram of a stereoscopic display system according to an embodiment of the invention.

Referring to FIG. 1, a stereoscopic display system 100 may include a 3D display 110, a storage device 120 and one or more processors (a processor 130 will be used as an example in the following description). The processor 130 is coupled to the 3D display 110 and the storage device 120. The stereoscopic display system 100 may be a single integrated system or a separate system. Specifically, the 3D display 110, the storage device 120 and the processor 130 in the stereoscopic display system 100 can be implemented as an all-in-one (AIO) electronic device, such as a notebook computer or a tablet computer. Alternatively, the 3D display 110 may be connected to the processor 130 of a computer system through a wired transmission interface or a wireless transmission interface.

The storage device 120 is coupled to the processor 130 and is configured to temporarily store data. Particularly, the storage device 120 may include a volatile storage circuit, a non-volatile storage circuit or the combination thereof. The volatile storage circuit is configured to store data, and program codes or instructions in a volatile manner. For example, the volatile storage circuit may include a random access memory (RAM) or a similar volatile storage medium. The non-volatile storage circuit is configured to store data in a non-volatile manner. For example, the non-volatile storage circuit may include a read only memory (ROM), a solid state drive (SSD), and/or a traditional hard disk drive (HDD) or a similar non-volatile storage medium. The number of the storage device 120 may be one or more, which is not limited by the invention. In some embodiments, the storage device 120 may be a graphics memory of a graphic processing unit (GPU).

The processor 130 is responsible for overall or partial operations of the stereoscopic display system 100. For example, the processor 130 may include a central processing unit (CPU), a graphic processing unit (GPU) or other programmable general-purpose or special-purpose microprocessor, a digital signal processor (DSP), a programmable controller, an application specific integrated circuit (ASIC), a programmable logic device (PLD), or other similar device or a combination of these devices. The number of the processor 130 may be one or more, which is not limited by the invention.

The 3D display 110 is coupled to the processor 130. The 3D display 110 may include a liquid crystal display (LCD), a light-emitting diode (LED) display, a field emission display (FED), an organic light-emitting diode (OLED) display, or other types of displays, and the disclosure is not limited thereto. In different embodiments, the 3D display 110 may include a naked-eye 3D display (also referred as an autostereoscopic display), a head mounted display (HMD) or other-type 3D display. The 3D display 110 may present a left-eye image and a right-eye image at the same time in stereoscopic effect. In some embodiments, the left-eye image and the right-eye image may be displayed at the same time based on a stereoscopic image display technology, such as a parallax barriers technology, a lenticular lenses technology or directional backlight technology.

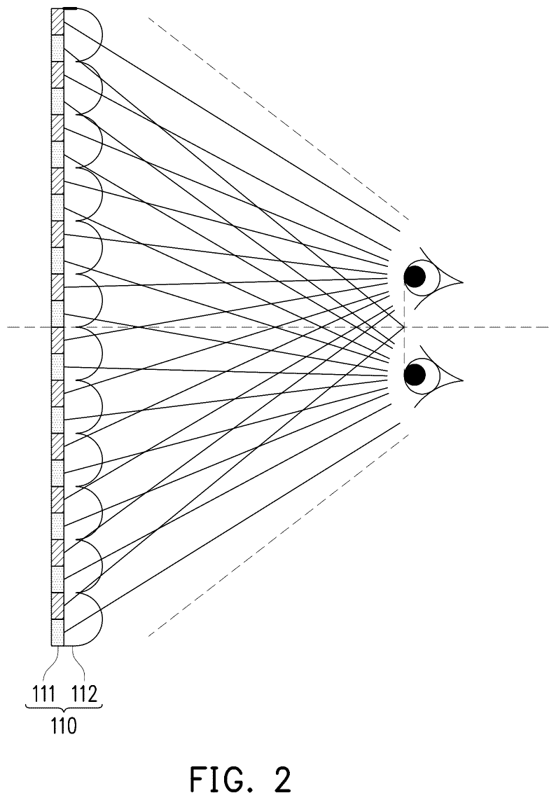

For example, FIG. 2 is a schematic diagram of a 3D display according to an embodiment of the invention.

Referring to FIG. 2, in an embodiment, the 3D display 110 may be a naked-eye 3D display, which can provide different images with aberrations to the left eye and the right eye through the principle of lens refraction, so that the viewer can experience a stereoscopic displaying effect. The 3D display 110 may include a display panel 111 and a lens layer 112. The lens layer 112 is disposed above the display panel 111, and the user may see a screen content provided by the display panel 111 through the lens layer 112. The invention does not limit the type and structure of the display panel 111, and the display panel 111 may also be a self-emissive display panel. When displaying the 3D composite frame, the 3D display 110 may place the pixels of the left-eye image for the left eye and the pixels of the left-eye image for the right eye respectively at the corresponding pixel positions of the display panel 111. The lens layer 112 refracts different display content (i.e., the left-eye image and the right-eye image) to different places in the space by refraction of light, so that the human eyes can respectively receive two different images with parallax. The structure and implementation of the 3D display 110 are not the focus of the invention and will not be described herein.

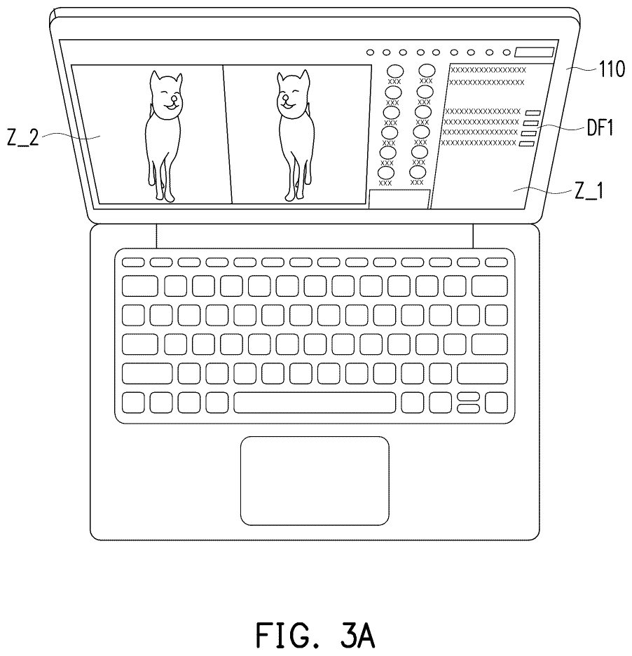

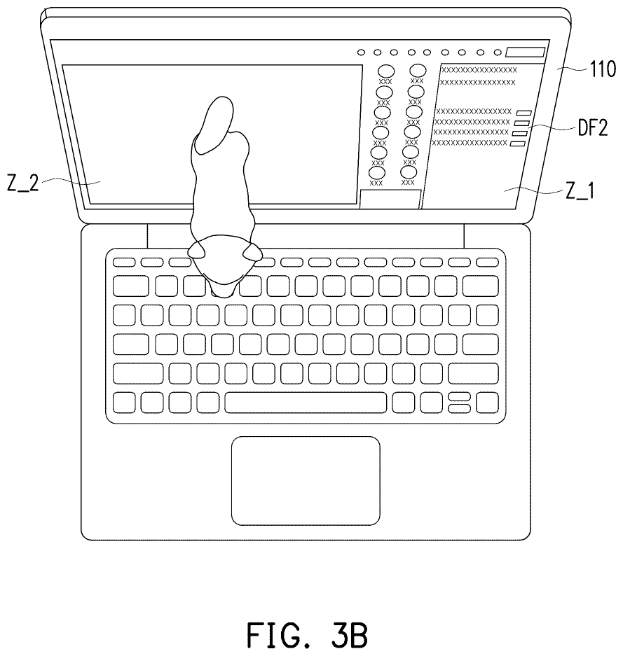

FIG. 3A is a schematic diagram of displaying a frame without stereoscopic displaying effect by the 3D display according to an embodiment of the invention. FIG. 3B is a schematic diagram of displaying a frame with stereoscopic displaying effect by the 3D display according to an embodiment of the invention.

Referring to FIG. 3A, in an embodiment, the processor 130 may execute an application program to display a display frame DF1, wherein the display frame DF1 of the application program includes a UI zone Z_1 and an image presentation zone Z_2.

In some embodiments, the application program may be a desktop application program and may be installed on a computer device to execute application software of various tasks such as an online video conference application, a browser program, a game program, a text editing program, a multimedia player program, a drawing program, etc., and the disclosure is not limited thereto. It should be noted that, in FIG. 3A, a side-by side image is displayed in the image presentation zone Z_2, and multiple control items and icons are displayed in the UI zone Z_1. When the 3D display 110 displays the display frame DF1, the user may only see 2D content which may include a stereo format image or may not include a stereo format image without the stereoscopic displaying effect.

In some embodiments, the processor 130 may receive a user command to trigger the 3D display 110 to provide stereoscopic displaying effect for the user. For example, the user may press the hot key to give the user command to the processor 130. Referring to FIG. 3B, in an embodiment, in response to receiving the user command, the 3D display 110 may display the display frame DF2, wherein the display frame DF2 of the application program also includes the UI zone Z_1 and the image presentation zone Z_2. It should be noted that, in FIG. 3B, the processor 130 may perform 3D composition operation, such as an image weaving operation, to the side-by side image of FIG. 3A according to the interpupillary distance information of the user, and the 3D composition result of the side-by side image is displayed in image presentation zone Z_2. Besides, multiple control items and icons in the UI border of the application program may remain unchanged and displayed in the UI zone Z_1. That is, the processor may extract the 3D content form a window of the application program and weave the right image and the left image of the 3D content. The image weaving result may be displayed at the position of the extracted 3D content. Such that, the user may simultaneously see a 3D object in the image presentation zone Z_2 and the UI border of the application program in the UI zone Z_1.

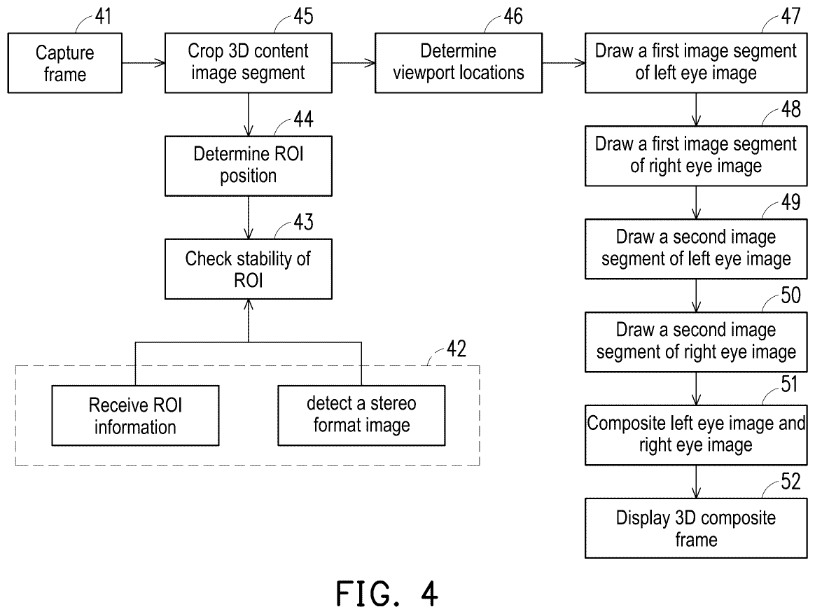

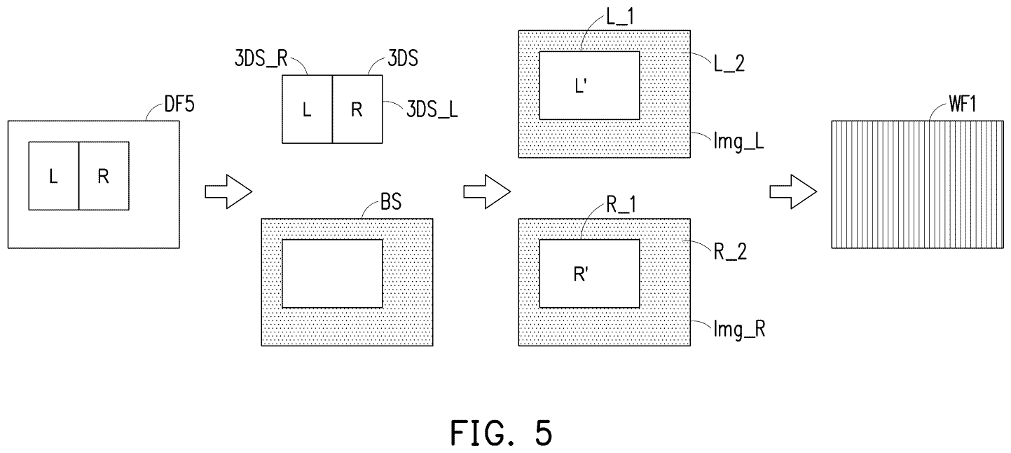

FIG. 4 is a schematic diagram of a stereoscopic display method according to an embodiment of the invention. FIG. 5 is a schematic diagram of generating a 3D composite frame based on an input frame according to an embodiment of the disclosure.

Referring to FIG. 1, FIG. 4 and FIG. 5, in an operation 41, the processor 130 may capture a display frame DF5. In some embodiments, the processor 130 may obtain the display frame DF5 from the graphic memory or system memory.

In some embodiments, the processor 130 may use a screen capture technique such as “Desktop Duplication API” of the Windows operating system to capture the display frame DF5 of the application program. In some embodiments, the processor 130 may capture the display frame DF5 of the application program from the window of the application program by using an application program interface provided by the operating system. For example, the processor 130 may use a window screen capture technique such as “Windows Graphics Capture API” of the Windows operating system to capture the display frame DF5 of the application program.

In an operation 45, the processor 130 may crop a 3D content image segment 3DS from the display frame DF5, wherein the display frame DF5 includes the 3D content image segment 3DS and a background content image segment BS. In some embodiments, the 3D content image segment 3DS may be copied and saved by the processor 130.

In some embodiments, the display frame DF5 may include a window of an application program. The background content image segment BS may be a user interface (UI) zone of the application program, and the 3D content image segment 3DS may be a video playback zone of the application program. For example, the application program may be an online video conference application, the background content image segment BS may be configured to present the control items or icons of the online video conference application. The 3D content image segment 3DS may be configured to playback the conference video.

It should be noted that, the processor 130 may crop a 3D content image segment 3DS according to a region of interest (ROI) position. Therefore, in an operation 42, the processor 130 may determine a region of interest (ROI) of the display frame DF5. For example, in FIGS. 3A and 3B, the image presentation zone Z_2 is the ROI to be cropped. The ROI information of the display frame DF5 may be obtained from the user or the application program. Alternatively, the ROI information of the display frame DF5 may be obtained by detecting a stereo format image within the display frame DF5.

In some embodiments, the processor 130 may receive the ROI information provided by an application program or a user input. For example, the processor 130 may receive the ROI information according to a dragging operation of the user. The user may perform the dragging operation to defined the size and the position of the ROI of the display frame DF5. Alternatively, the size and the position of the ROI may be determined and provided by the online video conference application.

In some embodiments, the processor 130 may detect a stereo format image within the display frame DF5. The processor 130 may obtain the ROI of the display frame DF5 according to the detected stereo format image within the display frame DF5. The stereo format image may be a side-by-side image, but which is not limited thereto. In detail, the processor 130 may detect a side-by-side image within the display frame DF5 by using a convolutional neural network (CNN) model. The side-by-side (SBS) image format is a stereo image format. A trained CNN model herein is a deep learning model constructed in advance through machine learning based on a training data set. The trained CNN model may be stored in the storage device 120. That is, model parameters (for example, the number of neural network layers and the weight of each of the neural network layer) of the trained CNN model have been determined by pre-training and stored in the storage device 120. The CNN model includes multiple convolutional layers that perform convolution operations, and the CNN model may be, for example, an object detection model or a semantic segmentation model. The processor 130 herein may use the CNN model to detect a rectangular image block that might conform to the side-by-side image format from display frame DF5.

In an operation 43 and operation 44, the processor 130 may determine the ROI position according to the ROI of the display frame DF5, wherein the 3D content image segment 3DS is cropped from the display frame DF5 according to the ROI position.

In the operation 43, the processor 130 may check stability of ROI. If the ROIs in the successive display frames are fixed or stay stability, the processor 130 may not update the ROI position in the operation 44. Otherwise, if the ROIs in the successive display frames are not fixed and unstable, the processor 130 may need to update the ROI position in the operation 44.

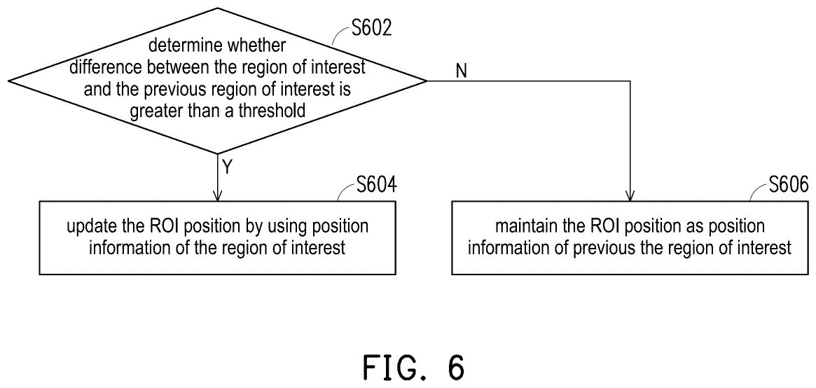

FIG. 6 is a flowchart of determining the ROI position for cropping the 3D content image segment according to an embodiment of the invention.

Referring to FIG. 6, in addition of detecting a stereo format image within the display frame DF5, the processor 130 may further detect a stereo format image within a previous display frame. The processor 130 may obtain a previous ROI of the previous display frame according to the detected stereo format image within the previous display frame. In the step S602, the processor 130 may determine whether difference between the ROI of the display frame DF5 and the previous ROI is greater than a threshold.

The difference between the ROI of the display frame DF5 and the previous ROI may include size difference, position difference or the combination thereof. For example, the processor 130 may determine whether the distance between a conner point of the ROI of the display frame DF5 and a conner point of the previous ROI is greater than a distance threshold. If the such distance is greater than the distance threshold, the processor 130 may determine the difference between the ROI of the display frame DF5 and the previous ROI is greater than the threshold. If the such distance is less than the distance threshold, the processor 130 may determine the difference between the ROI of the display frame DF5 and the previous ROI is not greater than the threshold. Alternatively, the processor 130 may determine whether the area difference between the ROI of the display frame DF5 and the previous ROI is greater than an area threshold.

In the step S604, in response to the difference between the region of interest and the previous ROI is greater than the threshold, the processor 130 may update the ROI position by using position information of the ROI of the display frame DF5. In the step S606, in response to the difference between the ROI and the previous ROI is less than the threshold, the processor 130 may maintain the ROI position as position information of previous the ROI. For example, assuming the position and the size of the ROI of the display frame DF5 is (x1, y1) and ‘A1’ and the position and the size of the previous ROI of the previous display frame is (x2, y2) and ‘A2’. If the difference between the ROI of the display frame DF5 and the previous ROI is greater than the threshold, the processor 130 may use the position (x1, y1) and the size ‘A1’ of the ROI to crop the 3D content image segment 3DS. If the difference between the ROI of the display frame DF5 and the previous ROI is not greater than the threshold, the processor 130 may use the position (x2, y2) and the size ‘A2’ of the previous ROI to crop the 3D content image segment 3DS. Based on the steps of FIG. 6, jitter and instability of display content may be prevented.

Returning to FIG. 4 and FIG. 5, in an operation 46, the processor 130 may determine viewport locations. In detail, in order to control the perceived depth of the virtual plane which is generated based on the background content image segment BS, the processor 130 may determine viewport locations (also referred to vision perceived depth) of the 3D content and background content. Such that, the 3D object of the 3D content image segment 3DS may be perceived behind or in front of the background content of the background content image segment BS by the user.

In an embodiment, the processor 130 may generate a first image segment of the left eye image and a first image segment of the right eye image according to the background content image segment. In an operation 47, the processor 130 may draw a first image segment L_2 of the left eye image Img_L according to the background content image segment BS. In an operation 48, the processor 130 may draw a first image segment R_2 of the right eye image Img_R according to the background content image segment BS. Further, in some embodiments, by determining viewport locations in operation 46, the processor 130 may obtain at least one pixel shift amount for shifting the pixels of the background content image segment BS. The first image segment L_2 of the left eye image Img_L or the first image segment R_2 of the right eye image Img_R may be drawn according to the shifted background content image segment.

In some embodiments, the processor 130 may perform a pixel shift processing horizontally on the background content image segment BS. The processor 130 may generate one of the first image segment L_2 of the left eye image Img_L and the first image segment R_2 of the right eye image Img_R according to the shifted background content image segment.

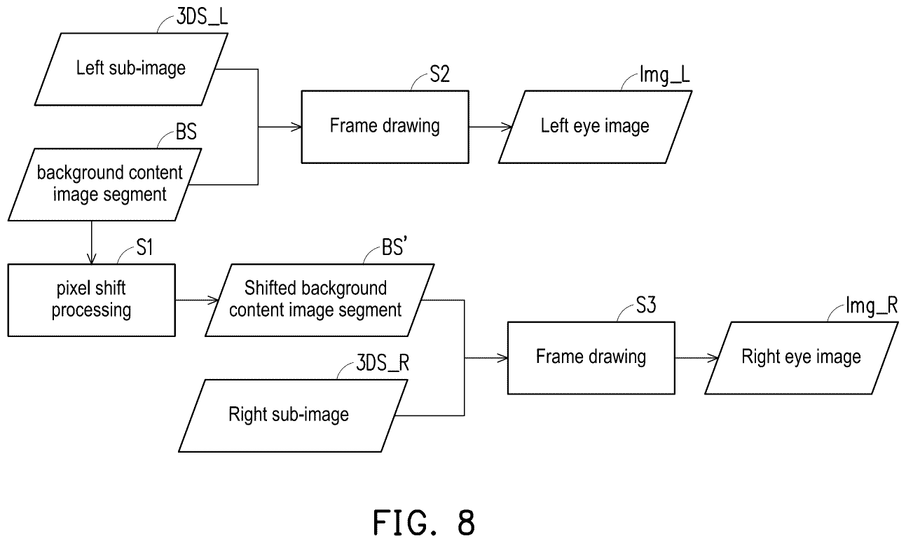

FIG. 8 is a schematic diagram of controlling perceived location of the background content image segment according to an embodiment of the disclosure.

Referring to FIG. 8, in operation S1, the processor 130 may perform a pixel shift processing horizontally on the background content image segment BS to obtain the shifted background content image segment BS′. In operation S2, the processor 130 may perform frame drawing according to the left sub-image 3DS_L and the background content image segment BS to obtain the left eye image Img_L. In operation S3, the processor 130 may perform frame drawing according to the right sub-image 3DS_R and the shifted background content image segment BS′ to obtain the right eye image Img_R.

Next, in an embodiment, the processor 130 may generate a second image segment L_1 of the left eye image Img_L according to the left sub-image, and generate a second image segment R_1 of the right eye image Img_R according to the right sub-image. In an operation 49, the processor 130 may draw a second image segment L_1 of the left eye image according to the left sub-image 3DS_L. In an operation 50, the processor 130 may draw a second image segment R_1 of the right eye image according to the right sub-image 3DS_R. In some embodiments, the processor 130 may perform image scaling on the left sub-image 3DS_L and the right sub-image 3DS_R, then draw the right eye image Img_R and the left eye image Img_L according to the scaling results.

It should be noted that, the processor 130 may obtain a left sub-image 3DS_L and a right sub-image 3DS_R based on the 3D content image segment 3DS. In the case of FIG. 5, since the 3D content image segment 3DS may be a side-by-side image, the processor 130 may obtain the left sub-image 3DS_L and a right sub-image 3DS_R by cropping the 3D content image segment 3DS in half. In other embodiments, if the 3D content image segment 3DS is not a stereo format image, the processor 130 may generate a stereo format image according to the 3D content image segment 3DS.

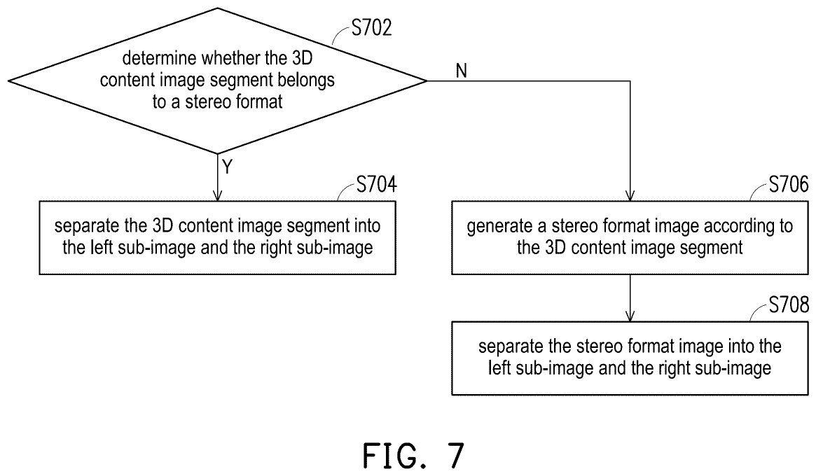

FIG. 7 is a flowchart of obtaining the left sub-image and the right sub-image according to an embodiment of the invention.

Referring to FIG. 7, in one embodiment, in step S702, the processor 130 may determine whether the 3D content image segment 3DS belongs to a stereo format. In step S704, the processor 130 may separate the 3D content image segment into the left sub-image 3DS_L and the right sub-image 3DS_R when the 3D content image segment 3DS belongs to a stereo format.

In step S706, the processor 130 may generate a stereo format image according to the 3D content image segment 3DS when the 3D content image segment 3DS does not belong to a stereo format. In step S708, the processor 130 may separating the stereo format image into the left sub-image and the right sub-image. For example, the 3D content image segment 3DS corresponding to a first viewing angle is obtained, and a depth information of the 3D content image segment 3DS is estimated. A pixel shift processing is performed on the 3D content image segment 3DS according to the depth information to generate a reference image corresponding to a second viewing angle. An image inpainting processing is performed on the reference image to obtain a restored image. The restored image and the 3D content image segment 3DS are merged to generate a stereo format image. The processor 130 may obtain the left sub-image 3DS_L and a right sub-image 3DS_R by cropping the stereo format image in half or in other way.

Returning to FIG. 4 and FIG. 5, in an operation 51, the processor 130 may composite the left eye image Img_L and the right eye image Img_R by an image weaving operation to generate a weaving frame WF1. That is, the pixels od the left eye image Img_L and the pixels of the right eye image Img_R may be interlaced in the weaving frame WF1. In an operation 52, the processor 130 may display the weaving frame WF1 by using the 3D display 110 which is a naked-eye 3D display. Accordingly, in one embodiment, the right eve of the user may receive the right sub-image 3DS_R and the background content image segment BS, and the right eve of the user may receive the left sub-image 3DS_L and the background content image segment BS. Such that, for example, in FIG. 3B, the user may see a floating object and a UI plane simultaneously.

In some embodiments, the operations performed by the processor 130 may be implemented to a graphics processing pipeline of GPU.

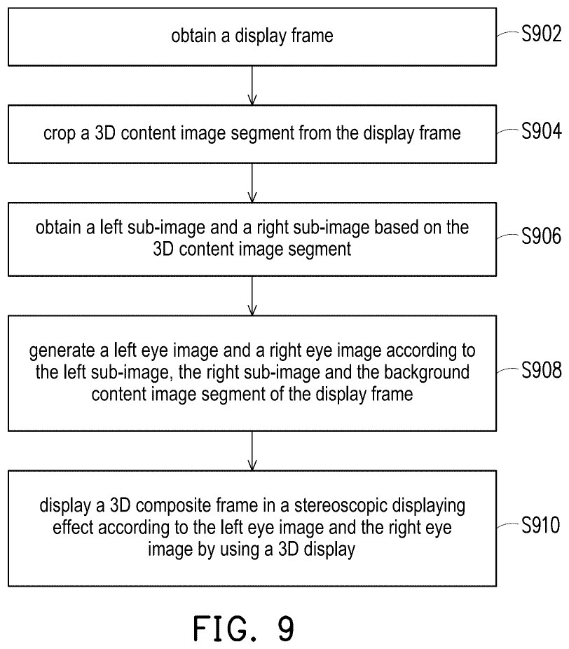

FIG. 9 is a flowchart of a stereoscopic display method according to an embodiment of the invention.

Referring to FIG. 9, in step 902, a display frame is obtained. In step 904, a 3D content image segment is cropped from the display frame, wherein the display frame comprises the 3D content image segment and a background content image segment. In step 906, a left sub-image and a right sub-image are obtained based on the 3D content image segment. In step 908, a left eye image and a right eye image are generated according to the left sub-image, the right sub-image and the background content image segment of the display frame. In step 910, a 3D composite frame is displaying in a stereoscopic displaying effect according to the left eye image and the right eye image by using a 3D display.

However, each step in FIG. 9 is described in detail above, and is not repeated herein. It should be mentioned that, each step in FIG. 9 may be implemented as a plurality of program codes or circuits, and the invention is not limited thereto. Moreover, the methods of FIG. 9 may be used with the above exemplary embodiments, and may also be used alone, and the invention is not limited thereto.

Based on the above, 2D content and 3D content may be displayed simultaneously by a 3D display. The application may allow side by side content in subregions of the screen to be visualized as a 3D scene in the same subregion.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

1. A stereoscopic display method, comprising:
obtaining a display frame;
determining a region of interest of the display frame;
determining a ROI position according to the region of interest of the display frame;
cropping a 3D content image segment from the display frame according to the ROI position, wherein the display frame comprises the 3D content image segment and a background content image segment;
obtaining a left sub-image and a right sub-image based on the 3D content image segment;
generating a left eye image and a right eye image according to the left sub-image, the right sub-image and the background content image segment of the display frame; and
displaying a 3D composite frame in a stereoscopic displaying effect according to the left eye image and the right eye image by using a 3D display.

2. (canceled)

3. The stereoscopic display method of claim 1, wherein the step of determining the region of interest of the display frame comprises:
receiving ROI information provided by an application program or a user input.

4. The stereoscopic display method of claim 1, wherein the step of determining the region of interest of the display frame comprises:
detecting a stereo format image within the display frame; and
obtaining the region of interest of the display frame according to the detected stereo format image within the display frame.

5. The stereoscopic display method of claim 4, further comprising:
detecting a stereo format image within a previous display frame;
obtaining a previous region of interest of the previous display frame according to the detected stereo format image within the previous display frame; and
determining whether difference between the region of interest and the previous region of interest is greater than a threshold,
wherein the step of determining the ROI position according to the region of interest of the display frame comprises:
in response to the difference between the region of interest and the previous region of interest is greater than the threshold, updating the ROI position by using position information of the region of interest; and
in response to the difference between the region of interest and the previous region of interest is less than the threshold, maintaining the ROI position as position information of previous the region of interest.

6. The stereoscopic display method of claim 1, wherein the step of obtaining the left sub-image and the right sub-image based on the 3D content image segment comprises:
separating the 3D content image segment into the left sub-image and the right sub-image when the 3D content image segment belongs to a stereo format.

7. The stereoscopic display method of claim 1, wherein the step of obtaining the left sub-image and the right sub-image based on the image content of the 3D content image segment comprises:
generating a stereo format image according to the 3D content image segment when the 3D content image segment does not belong to a stereo format; and
separating the stereo format image into the left sub-image and the right sub-image.

8. The stereoscopic display method of claim 1, wherein the step of displaying the 3D composite frame in a stereoscopic displaying effect according to the left eye image and the right eye image by using the 3D display comprising:
compositing the left eye image and the right eye image by an image weaving operation to generate a weaving frame; and
displaying the weaving frame by using the 3D display which is a naked-eye 3D display.

9. The stereoscopic display method of claim 1, wherein the step of generating the left eye image and the right eye image according to the left sub-image, the right sub-image and the background content image segment comprising:
generating a first image segment of the left eye image and a first image segment of the right eye image according to the background content image segment,
generating a second image segment of the left eye image according to the left sub-image; and
generating a second image segment of the right eye image according to the right sub-image.

10. The stereoscopic display method of claim 9, wherein the step of generating the second image segment of the left eye image and the second image segment of the right eye image according to the background content image segment comprising:
performing a pixel shift processing horizontally on the background content image segment;
generating one of the first image segment of the left eye image and the first image segment of the right eye image according to the shifted background content image segment.

11. The stereoscopic display method of claim 1, wherein the display frame comprises a window of an application program, the background content image segment comprises a user interface (UI) zone of the application program, and the 3D content image segment comprises a video playback zone of the application program.

12. A stereoscopic display system, comprising:
a storage device;
a 3D display; and
at least one processor, coupled to the storage device and the 3D display,
wherein the at least one processor is configured to:
obtaining a display frame;
determine a region of interest of the display frame;
determine a ROI position according to the region of interest of the display frame;
cropping a 3D content image segment from the display frame according to the ROI position, wherein the display frame comprises the 3D content image segment and a background content image segment;
obtaining a left sub-image and a right sub-image based on the 3D content image segment;
generating a left eye image and a right eye image according to the left sub-image, the right sub-image and the background content image segment of the display frame; and
displaying a 3D composite frame in a stereoscopic displaying effect according to the left eye image and the right eye image by using the 3D display.

13. (canceled)

14. The stereoscopic display system of claim 11, wherein the processor is configured to:
detect a stereo format image within the display frame; and
obtain the region of interest of the display frame according to the detected stereo format image within the display frame.

15. The stereoscopic display system of claim 14, wherein the processor is configured to:
detect a stereo format image within a previous display frame;
obtain a previous region of interest of the previous display frame according to the detected stereo format image within the previous display frame;
determine whether difference between the region of interest and the previous region of interest is greater than a threshold;
in response to the difference between the region of interest and the previous region of interest is greater than the threshold, update the ROI position by using position information of the region of interest; and
in response to the difference between the region of interest and the previous region of interest is less than the threshold, maintain the ROI position as position information of previous the region of interest.

16. The stereoscopic display system of claim 12, wherein the processor is configured to:
separate the 3D content image segment into the left sub-image and the right sub-image when the 3D content image segment belongs to a stereo format; and
generating a stereo format image according to the 3D content image segment when the 3D content image segment does not belong to a stereo format, and separating the stereo format image into the left sub-image and the right sub-image.

17. The stereoscopic display system of claim 12, wherein the processor is configured to:
composite the left eye image and the right eye image by an image weaving operation to generate a weaving frame; and
display the weaving frame by using the 3D display which is a naked-eye 3D display.

18. The stereoscopic display system of claim 12, wherein the processor is configured to:
generate a first image segment of the left eye image and a first image segment of the right eye image according to the background content image segment,
generate a second image segment of the left eye image according to the left sub-image; and
generate a second image segment of the right eye image according to the right sub-image.

19. The stereoscopic display system of claim 18, wherein the processor is configured to:
perform a pixel shift processing horizontally on the background content image segment;
generate one of the first image segment of the left eye image and the first image segment of the right eye image according to the shifted background content image segment.

20. The stereoscopic display system of claim 12, wherein the display frame comprises a window of an application program, the background content image segment comprises a user interface (UI) zone of the application program, and the 3D content image segment comprises a video playback zone of the application program.
